(19) United States
(12) Patent Application Publication
(10) Pub. No.: US 2009/0251406 A1
(43) Pub. Date: Oct. 8, 2009

(54) System and Method for Selective Activation and Deactivation of an Information Handling System Input Output Device

(76) Inventors: Philip Seibert, Round Rock, TX (US); Marie Chagny, Austin, TX (US); Kyle David Spiess, Round Rock, TX (US); Charles Robison, Round Rock, TX (US); Angela Stern, Round Rock, TX (US); Yin-Cheung Ma, Austin, TX (US); John Lerma, Cedar Park, TX (US)

Correspondence Address: HAMILTON & TERRILE, LLP, P.O. BOX 203518, AUSTIN, TX, 78720, US

(21) Appl. No.: 12/060,989

(22) Filed: Apr. 2, 2008

(51) Int. Cl. G09G 5/00

(52) U.S. Cl. 345/156

(57) ABSTRACT

An information handling system has a chassis and a lid, the lid rotating between a closed position and a tablet position. An indicator coupled to the lid, such as a magnet, aligns with a first detector coupled to a chassis of the information handling system, such as a Hall effect detector, in the tablet position so that the detector signals to a position detector module to disable a keyboard of the information handling system. The indicator aligns with a second detector coupled to the chassis in a closed configuration so that the second detector signals to the position detector module to enter a power down state.

### BACKGROUND OF THE INVENTION

1. Field of the Invention

The present invention relates in general to the field of information handling system input output devices, and more particularly to a system and method for selective activation and deactivation of an information handling system input output device.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Conventionally, information handling systems were built from a variety of different components into desktop systems that interact with peripherals, such as keyboards and displays, through external cables. As components used to build information handling systems have increased in capability and decreased in size and price, end users have begun to adopt portable information handling systems in the place of desktop information handling systems. Portable information handling systems have an integrated power supply, keyboard and display that allow an end user to use the system free from external cables. Conventionally, portable information handling systems are built in a chassis that has a rotationally coupled lid, known as a clamshell configuration. When rotated to a closed configuration with the lid shut against the chassis, portable information handling systems are protected from damage. When rotated to an open position with the lid away from the chassis to expose the display integrated in the lid and the keyboard integrated in the chassis, portable information handling systems provide a convenient platform for interacting with an end user.

Portable information handling systems have recently been modified to have a tablet configuration. The tablet configuration allows for the normal clamshell rotation in a horizontal axis between open and closed positions but also includes rotation about a vertical axis. From the open position, rotation of 180 degrees about the vertical axis followed by rotation to a closed position results in the tablet configuration in which the display is exposed and the backside of the lid abuts against the keyboard. In tablet portable information handling systems, the display includes a touch screen so that an end user interacts with the information handling system by writing directly on the display screen. In order to keep the size of the system to a minimum, the display typically is a very thin backlit LCD that deflects easily with pressure. While in tablet mode, end user inputs can sometimes pressure against the keyboard beneath, causing incidental keyboard strokes, button presses or touchstick movements.

### SUMMARY OF THE INVENTION

Therefore a need has arisen for a system and method which disables the keyboard of a tablet information handling system when in a tablet configuration.

In accordance with the present invention, a system and method are provided which substantially reduce the disadvantages and problems associated with previous methods and systems for selectively enabling and disabling an information handling system keyboard. A detector disposed in the chassis of the information handling system detects an indicator in the lid of the information handling system when aligned by configuration in a tablet position. Detection of the tablet position results in disabling of the information handling system keyboard to prevent inadvertent inputs, such as by pressing of an end user on the information handling system touchscreen display.

More specifically, an information handling system has plural processing components disposed in a chassis to process information. A motherboard supports communication between the processing components. A lid rotationally coupled to the chassis moves from a closed position to an open position and a tablet position. A magnet indicator disposed in the lid aligns with a first Hall effect detector on one side of the chassis when configured in the closed position. The magnet indicator aligns with a second Hall effect detector on an opposing side of the chassis when configured in the tablet position. Each Hall effect detector activates when proximate the magnet to output a disable signal. A position detector module, such as firmware instructions running on a chipset of the information handling system, interfaces with the Hall effect detector to accept the disable signals. When the first Hall effect detector outputs a disable signal, the position detector module commands a power down state for the information handling system, such as an ACPI power down state. When the second Hall effect detector outputs a disable signal, the position detector module commands a disabling of the keyboard, touchstick and touchpad mouse.

The present invention provides a number of important technical advantages. One example of an important technical advantage is that a tablet information handling system keyboard is selectively enabled and disabled based on the configuration of the system. When in the tablet configuration, automatic detection of the proximity of the backside of the display to the keyboard allows automatic disabling of the keyboard. Rotation away from the tablet configuration removes the detection of the display backside proximate to the keyboard so that the keyboard is automatically enabled. By automatically disabling the keyboard when a risk of inadvertent inputs exists, such inadvertent inputs become much less likely. For example, with particularly thin LED backlit LCDs, disabling the keyboard prevents end user pressing on the LCD to translate through the thin structure of the display to activate the keyboard.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a blow-up view of a tablet portable information handling system with a position indicator and detector;

FIG. 2 depicts a side perspective view of a tablet portable information handling system in a closed position;

FIG. 3 depicts a side perspective view of a tablet portable information handling system in an open position;

FIG. 4 depicts a side perspective view of a tablet portable information handling system with the lid rotating about a vertical axis to transition to the tablet position;

FIG. 5 depicts a side perspective view of a tablet portable information handling system with the lid rotated 180 degrees from the open position in preparation for rotation about the horizontal axis to the tablet position; and

FIG. 6 depicts a side perspective view of a tablet portable information handling system in a tablet position.

### DETAILED DESCRIPTION

Alignment of a Hall effect detector and a magnet in a tablet configuration of an information handling system signals for disabling the information handling system keyboard. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

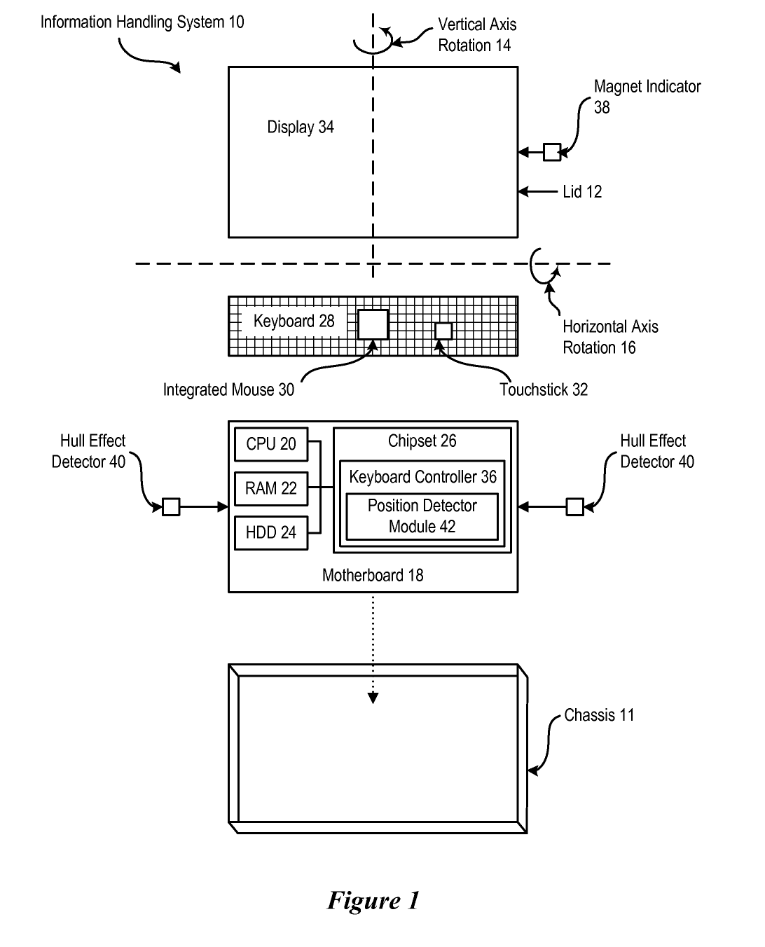

Referring now to FIG. 1, a blow-up view depicts a tablet portable information handling system 10 with a position indicator and detector. Tablet portable information handling system 10 has a lid 12 rotationally coupled to a chassis 11 so that lid 12 rotates about a vertical axis of rotation 14 and a horizontal axis of rotation 16. Chassis 11 provides support for a motherboard 18 that includes sockets, connectors and integrated wire lines for communication between a plurality of processing components, such as a CPU 20, RAM 22, a hard disk drive 24 and a chipset 26. The processing components process information with applications running through an operating system based on inputs communicated through a keyboard 28 having an integrated mouse 30 and touchstick 32. Keyboard 28 couples to chassis 14 over top of the processing components and motherboard 18. A display 34 presents information received from the processing components as visual images and includes a touchscreen to accept inputs from an end user. The presentation and acceptance of information at display 34 is coordinated by chipset 26. The acceptance of inputs from keyboard 28, mouse 30 and touchstick 32 is coordinated by a keyboard controller 36, such as firmware instructions running on a processor within chipset 36.

In operation, information handling system 10 interacts with an end user in an open configuration and in a tablet configuration. In order to manage the enabling and disabling of I/O devices, such as keyboard 28, mouse 30, touchstick 32 and display 34, one or more magnet indicators 38 and Hall effect detectors 40 are disposed in lid 12 and chassis 11. A position detector module 42, such as firmware running on keyboard controller 36 or other portions of chipset 26, monitors Hall effect detectors 40 for indications of the position of lid 12 relative to chassis 11 to enable and disable I/O devices. In the closed position, display 34 closes over top of keyboard 28 to bring magnet indicator 38 proximate to a Hall effect detector 40 whose activation indicates the closed position. Once magnet indicator 38 is proximate enough to activate Hall effect detector 40, Hall effect detector 40 sends a disable signal to position detector 42 indicating that information handling system 10 is in the closed position. For example, Hall effect detector 40 is coupled to motherboard 18 and interfaced with chipset 26 through a wire line. Position detector module 42 is firmware instructions running on a processor within chipset 26, such as keyboard controller 36. When a disable signal from a Hall effect detector 40 indicates a closed position, position detector module 42 commands a power down state, such as an ACPI power down state, by communicating the closed position detection to an appropriate part of chipset 26 or to an operating system running on CPU 20.

In the open position, magnet indicator 38 is distal Hall effect detectors 40 so that no signals are generated. Rotation about vertical axis 14 provides a convenient display platform for an end user to provide a view of display 34 to others. When lid 12 rotates 180 degrees about vertical axis 14 and then rotates about horizontal axis 16 to come in proximity with keyboard 28 in the tablet position, magnet indicator 38 is aligned with a Hall effect detector 40 located on an opposing end of chassis 11 and coupled to motherboard 18. As magnet indicator 38 comes in proximity with the opposing Hall effect detector 40, Hall effect detector 40 provides a disable signal to position detector module 42. When position detector module 42 receives a disable signal from the Hall effect detector 40, position detector module 42 disables keyboard 28, including integrated mouse 30 and touchstick 32. Disabling keyboard 28 prevents inadvertent activation of keyboard inputs by an end user's inputs through an exposed touchscreen of display 34. When lid 12 rotates from the tablet position back to the open position, magnet indicator 38 moves distal Hall effect detector 40 to remove the disable signal from position detector module 42. As the disable signal is removed, position detector module 42 enables keyboard 28 to again accept inputs from an end user. In alternative embodiments, other types of proximity detectors may be used instead of magnet indicator 38 and Hall effect detector 40, such as a reed switch, a magnetoresistive switch, or an infrared detector. In other alternative embodiments, the type, number and location of detectors and indicators may be moved to alternative positions in the chassis and lid.

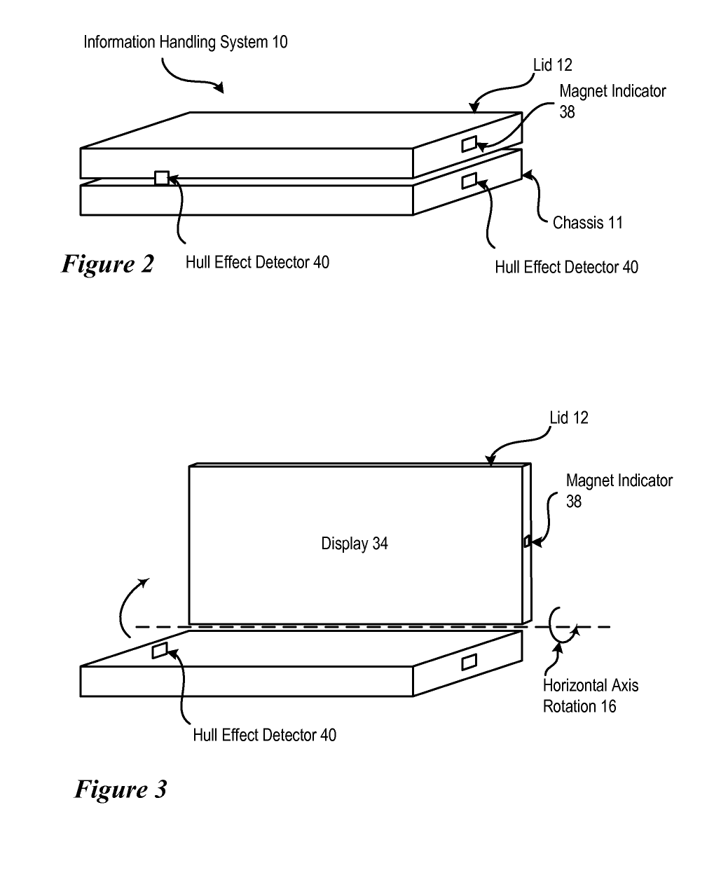

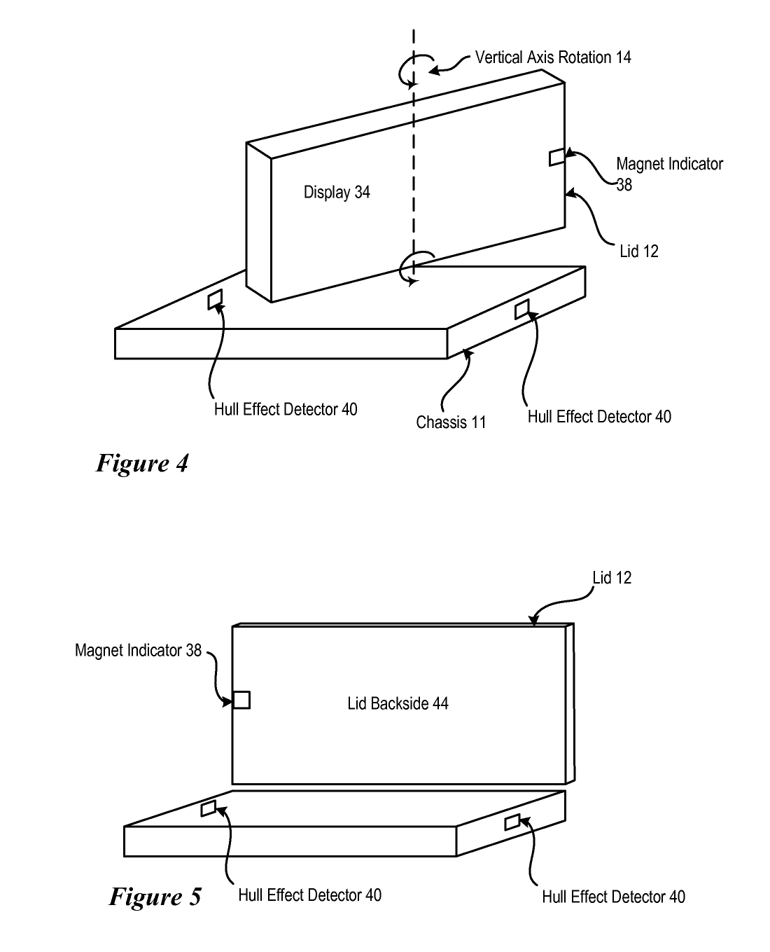

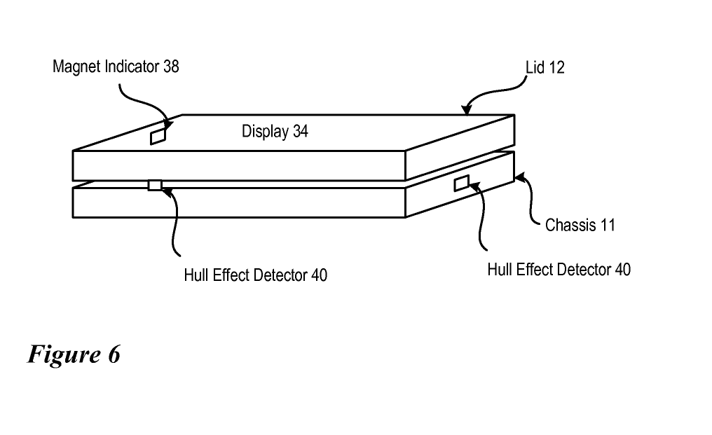

Referring now to FIG. 2, a side perspective view depicts a tablet portable information handling system 10 in a closed position. From the front of information handling system 10, the right side Hall effect detector 40 is activated by magnet indicator 38 to indicate the closed position. In the closed position, ACPI power down states are initiated, such as a standby, suspend or off state. FIG. 3 depicts a side perspective view of a tablet portable information handling system 10 in an open position. Magnet indicator 38 is distal both Hall effect detectors 40 so that neither sends a disable signal. FIG. 4 depicts a side perspective view of a tablet portable information handling system 10 with the lid rotating about a vertical axis 14 to transition to the tablet position. FIG. 5 depicts a side perspective view of a tablet portable information handling system 10 with the lid 12 rotated 180 degrees from the open position in preparation for rotation about the horizontal axis to the tablet position. The backside 44 of lid 12 is directed towards the keyboard and magnet indicator 38 is now on the opposite side of chassis 11 relative to the open position depicted by FIG. 3. FIG. 6 depicts a side perspective view of a tablet portable information handling system 10 in a tablet position. For instance, from the position depicted in FIG. 5, lid 12 is rotated about the horizontal axis to close over the keyboard, leaving display 34 exposed. Because the keyboard is disabled by the alignment of magnet indicator 38 and Hall effect detector 40, end user inputs to a touchscreen display 34 will not cause inadvertent inputs at the keyboard.

Although the present invention has been described in detail, it should be understood that various changes, substitutions and alterations can be made hereto without departing from the spirit and scope of the invention as defined by the appended claims.

What is claimed is:

1. An information handling system comprising:
a chassis;
a lid rotationally coupled to the chassis, the lid operable to rotate about a horizontal axis and a vertical axis relative to the chassis, the lid further operable to rotate between a closed position and an open position and between the open position and a tablet position;
a motherboard disposed in the chassis;
plural processing components disposed on the motherboard, the processing components operable to process information;
a keyboard disposed in the chassis, the keyboard operable to accept inputs and to communicate the inputs to the processing components;
a display integrated in the lid and interfaced with the processing components, the display operable to present information as visual images; and
an indicator and a detector, one associated with the display and the other associated with the chassis, the indicator and detector aligned to oppose each other when the lid rotates to the tablet position, the detector operable to command disabling of the keyboard to accept inputs when the indicator and detector align.

2. The information handling system of claim 1 wherein the indicator comprises a magnet disposed in the lid.

3. The information handling system of claim 2 wherein the detector comprises:
a Hall effect detector operable to output a disable signal when the magnet aligns in the tablet position; and
a detector module interfaced with the Hall effect detector, the detector module operable to disable the keyboard when the Hall effect detector outputs the disable signal.

4. The information handling system of claim 3 wherein detector module comprises firmware running on a processing component.

5. The information handling system of claim 4 wherein the processing component comprises a keyboard controller.

6. The information handling system of claim 1 further comprising a second detector, the second detector aligned to oppose the indicator when the lid rotates to the closed position, the second detector operable to command power down of at least some of the processing components when the indicator and second detector align.

7. The information handling system of claim 6 wherein the power down of at least some of the processing components comprises commanding one or more ACPI power down states.

8. The information handling system of claim 1 wherein the keyboard comprises an integrated mouse.

9. The information handling system of claim 1 wherein the keyboard comprises a touchstick.

10. A method for managing operation of input/output devices of an information handling system, the method comprising:
disposing first and second detectors on opposing sides of an information handling system chassis;
disposing an indicator on one side of an information handling system lid;
determining that the information handling system is in a closed configuration if the first detector detects the indicator; and
determining that the information handling system is in a tablet configuration if the second detector detects the indicator.

11. The method of claim 10 wherein the indicator comprises a magnet disposed in the lid.

12. The method of claim 11 wherein the first and second detectors comprise Hall effect detectors.

13. The method of claim 10 further comprising:
disabling a keyboard of the information handling system if the second detector detects the indicator.

14. The method of claim 10 further comprising:
disabling an integrated mouse of the information handling system if the second detector detects the indicator.

15. The method of claim 10 further comprising:
disabling a touchstick of the information handling system if the second detector detects the indicator.

16. The method of claim 10 further comprising:
entering a power down state with the information handling system if the first detector detects the indicator.

17. A system for managing operation of input/output devices of an information handling system, the system comprising:
a detector coupled to an information handling system chassis, the detector operable to output a disable signal if proximate an indicator;
an indicator coupled to an information handling system lid to align proximate the detector when the lid is in a tablet configuration relative to the chassis; and
a position detector module interfaced with the detector and operable to disable a keyboard if the detector outputs a disable signal.

18. The system of claim 17 wherein the detector comprises a Hall effect detector and the indicator comprises a magnet.

19. The system of claim 17 further comprising a second detector coupled to the chassis to align proximate the indicator when the lid is in a closed configuration, the second detector operable to output a disable signal if proximate an indicator and wherein the position detector module is further operable to command a power down state if the second detector outputs a disable signal.

20. The system of claim 17 wherein the position detector module comprises firmware running on a keyboard controller.
